(19) United States
(12) Patent Application Publication
(10) Pub. No.: US 2023/0260259 A1
(43) Pub. Date: Aug. 17, 2023

(54) METHOD AND DEVICE FOR TRAINING A NEURAL NETWORK

(71) Applicant: Robert Bosch GmbH, Stuttgart (DE)

(72) Inventors: Maximilian Menke, Diekholzen (DE); Thomas Wenzel, Hamburg (DE)

(21) Appl. No.: 18/167,701

(22) Filed: Feb. 10, 2023

(30) Foreign Application Priority Data
Feb. 17, 2022 (DE) 10 2022 201 679.3

(51) Int. Cl. G06V 10/774; G06V 10/77; G06V 20/50; G06V 20/70

(52) U.S. Cl. CPC G06V 10/774; G06V 10/7715; G06V 20/50; G06V 20/70

(57) ABSTRACT

Computer-implemented method for training a machine learning system. The method includes: providing a source image from a source domain and a target image of a target domain; determining a first generated image based on the source image using a first generator, and determining a first reconstruction based on the first generated image using a second generator; determining a second generated image based on the target image using the second generator, and determining a second reconstruction based on the second generated image using the first generator; determining a first loss value, the first loss value characterizing a first difference between the source image and the first reconstruction, and determining a second loss value, the second loss value characterizing a second difference between the target image and the second reconstruction; and training the machine learning system based on the first loss value and/or the second loss value.

### CROSS REFERENCE

The present application claims the benefit under 35 U.S.C. § 119 of German Patent Application No. DE 10 2022 201 679.3 filed on Feb. 17, 2022, which is expressly incorporated herein by reference in its entirety.

### FIELD

The present invention relates to a method for training a machine learning system, a method for training an object detector, a method for operating a control system, a computer program, and a machine-readable storage medium.

### BACKGROUND INFORMATION

Many modern technical systems use machine learning methods to process data received from an environment of the technical system. These methods are typically capable of making predictions with respect to the data, viz., based on statistical knowledge obtained based on a set of training data.

Machine learning systems typically encounter problems if a statistical distribution of data processed by the machine learning system during the inference time differs from a statistical distribution of data used to train the machine learning system. In the field of machine learning, this issue is also known as a domain shift.

There are many examples of technical systems that are subject to a more or less natural or inevitable domain shift. For example, in the field of at least partially autonomous vehicles, the situation arises that new vehicles can be observed on the road in regular cycles. For sensors of at least partially autonomous vehicles, such as LIDAR sensors, camera sensors, or radar sensors, such vehicles typically also result in measurements that are thus unknown in potential training sets since the vehicles and thus also the sensor measurements recorded by them are new by definition.

Another form of domain shift may arise when a switch between two product generations of a product occurs. For example, there are camera sensors that comprise machine learning systems in order to evaluate an environment recorded by the camera (i.e., a camera image of the environment) with respect to positions of objects, for example. Training of such machine learning systems regularly requires a large amount of training data. If the product generation of the camera now changes, e.g., a new image sensor is used, the machine learning system, without adaptation, typically no longer achieves the same predictive accuracy as in the previous camera generation. A product generation change would therefore mean determining new training data for the machine learning system. While the pure data themselves are typically inexpensive to acquire, the annotations necessary for training are much more difficult to obtain and more costly since human experts typically have to create the annotations.

### SUMMARY

Advantageously, a method according to the present invention allows for an adaptation of a source domain to a target domain (domain adaptation). In contrast to conventional methods, the method allows for the introduction of a priori information with regard to which parts of the source domain are in particular important in the adaptation to the target domain. This a priori information is determined in an automated manner. The method is therefore advantageously able to perform an unsupervised domain adaptation. The inventors were able to determine that the a priori information makes domain adaptation more accurate.

In a first aspect, the present invention relates to a computer-implemented method for training a machine learning system. According to an example embodiment of the present invention, the method includes the following steps:
providing a source image from a source domain and a target image of a target domain;
determining a first generated image based on the source image by means of a first generator of the machine learning system, and determining a first reconstruction based on the first generated image by means of a second generator of the machine learning system;
determining a second generated image based on the target image by means of the second generator, and determining a second reconstruction based on the second generated image by means of the first generator;
determining a first loss value, wherein the first loss value characterizes a first difference of the source image and of the first reconstruction, wherein the first difference is weighted according to a first attention map, and determining a second loss value, wherein the second loss value characterizes a second difference of the target image and of the second reconstruction, wherein the second difference is weighted according to a second attention map;
training the machine learning system by training the first generator and/or the second generator based on the first loss value and/or the second loss value.

The machine learning system can in this respect be understood as being designed to receive an image as input and to determine, based on this input, a further image as output. By means of the method, the machine learning system can be trained to convert images of the source domain into images of the target domain.

A domain can be understood as a probability distribution from which images can be generated. The method according to the present invention can therefore also be understood as transforming images from a probability distribution (source domain) into a further probability distribution (target domain).

An image can in particular be understood as a sensor recording or also a measurement of a sensor. In particular, camera sensors, LIDAR sensors, radar sensors, ultrasonic sensors, or thermal imaging cameras may be used as sensors that can determine images as measurements. However, an image may also be generated synthetically, for example based on a computer simulation, for example by rendering a virtual world. For such synthetic images, it is often very easily possible to determine annotations in an automated manner, wherein further images can then be generated from the synthetic images by means of the method, which further images, resembles in their appearance an image of, e.g., a camera sensor.

According to an example embodiment of the present invention, in order to determine the first generated image, the machine learning system uses a first generator that can be trained during the method. In the context of the present invention, a generator can be understood as a machine learning method that determines an output image based on an input image. In particular, the generators described can be understood as determining an image that is of the same size as the image that is used as input.

In order to enable a relationship and thus a suitable adaptation from the source domain to the target domain, according to an example embodiment of the present invention, the machine learning system furthermore comprises a second generator designed to project images from the target domain back to the source domain. If an image is first processed by a generator of the machine learning system and the image thus determined is then processed by the other generator, the image determined by the other generator can be understood as a reconstruction. The aim of conventional methods is to train the generators for, in each case, one image from the source domain and one image from the target domain such that the one respective reconstruction is identical to the respective image. Advantageously, the use of the first attention map and of the second attention map enables the training to be controlled in such a way that specific regions of the image of the source domain and of the image of the target domain can be categorized as being particularly important. Preferably, the regions thus declared by the attention maps may contain objects that can be recognized in the image. The machine learning method is thus enabled to put the focus during reconstruction in particular on objects. The inventors could determine that this enables a domain adaptation that can transfer objects from images of the source domain very accurately into images of the target domain. In this way, for example, a training data set can be determined for an object detector of the target domain, wherein the training images can be generated from the images of a data set from the source domain, and the annotations of the images of the data set can be used as annotations of the generated training images.

In contrast to conventional methods, during the training, a priori information is supplied to the machine learning system by means of the first attention map and the second attention map, which information indicates to the machine learning system which parts are particularly relevant for the domain adaptation.

In preferred embodiments of the present invention, it is possible that the first attention map respectively characterizes for pixels of the source image whether or not a pixel belongs to an object depicted in the source image, and/or wherein the second attention map respectively characterizes for pixels of the target image whether or not a pixel belongs to an object depicted in the target image.

An image and a correspondingly determined reconstruction can in particular be compared pixel by pixel, i.e., a difference between pixels at the same positions in image and reconstruction can in each case be determined, for example, an Euclidean distance or a square of the Euclidean distance. An attention map can then be used to assign to each of these determined differences a weight that a difference is to receive according to the attention map. Pixels of the image can in particular be weighted according to whether or not they characterize an object. An attention map can be understood as an image with a channel or matrix. The differences determined between the image and the reconstruction can also be understood as an image with a channel or a matrix, in which a difference at a specific position respectively characterizes the difference of the pixels of the image and of the reconstruction at the same position. A weighting of the values of the matrix of difference values can then be determined by means of a Hadamard product of the attention map with the matrix of difference values. Based thereon, a loss value can then be determined by, for example, summing, preferably summing weighted, all elements of the result of the Hadamard product.

In one example embodiment of the present invention, it is possible for the first attention map to assign to each pixel of the source image a weight 1 if the pixel belongs to an object depicted in the image, and a weight 0 if the pixel does not belong to any object. In the typical way of speaking in the field of object detection, an attention map can therefore be designed to segment the foreground from the background, viz., as indicated by the different values (1 for foreground, 0 for background). Alternatively, or additionally, it is possible for the second attention map to assign to each pixel of the target image a weight 1 if the pixel belongs to an object depicted in the image, and a weight 0 if the pixel does not belong to any object.

Alternatively, it is also possible for the first attention map and/or the second attention map to respectively characterize probabilities with which corresponding pixels belong to an object.

In preferred embodiments of the present invention, it is possible that the first attention map is determined based on the source image by means of an object detector and/or wherein the second attention map is determined based on the target image by means of the object detector.

The object detector may in particular be a machine learning system, for example, a neural network designed for object detection. The object detector may preferably be trained on images of the source domain. In order to train the machine learning system proposed in the invention, the object detector may then determine the first attention map based on the source image. For example, the object detector may assign the value 1 in the first attention map to all pixels of the source image that the object detector recognizes as belonging to an object and may set all other values of the attention map to the value 0. Similarly, the object detector may assign the value 1 in the second attention map to all pixels of the target image that the object detector recognizes as belonging to an object and may set all other values of the attention map to the value 0.

Typically, object detectors are designed to assign, to each pixel in the image, a probability with which the pixel is an object. For example, common neural networks for object detection output an object detection in the form of a bounding box and a probability with which the bounding box is an object known to the neural network. The pixels within the bounding box may each be occupied with the probability in the attention map. If the neural network determines overlapping object detections, the greatest probability determined for a respective pixel may be used.

Preferably, in the respective embodiments of the method of the present invention, it is also possible for the steps of the method to be performed iteratively and for the object detector to determine a first attention map for a source image in each iteration and/or to determine a second attention map for a target image in each iteration.

In general, a source image can be understood as originating from a data set of the source domain and a target image can be understood as originating from a data set of the target domain. In particular, several images of the respective data sets can be used for the training and the steps of the training method can be carried out iteratively. In particular, the images of the target domain may not be annotated. The object detector may then, in each iteration step of the training, respectively determine, for the source image and the target image of the iteration, object detections on the basis of which the first attention map and the second attention map, respectively, can then be determined as explained in one of the embodiments described above. An advantage here is that iterative training can better transform the images of the data set of the source domain with each iteration step, i.e., the images transformed from the source domain are more and more similar to those of the target domain.

Preferably, the machine learning system trained in the method characterizes a neural network, in particular a CycleGAN. Alternatively, the machine learning system may also characterize a different neural network that enables image-to-image translation, for example a MADAN or a VAE-GAN.

In a further aspect, the present invention relates to a computer-implemented method for training an object detector. According to an example embodiment of the present invention, the method includes the follow steps:
providing an input image and an annotation, wherein the annotation characterizes a position of at least one object depicted in the input image;
determining an intermediate image by means of the first generator of a machine learning system trained according to one of the embodiments of the first aspect of the invention;
training the object detector, wherein the object detector is trained in such a way that for the intermediate image as input, the object detector predicts the object or objects that are characterized by the annotation.

According to an example embodiment of the present invention, the method for training the object detector can be understood as first determining, by means of a trained machine learning system, based on images of the source domain, images corresponding in appearance to images of the target domain, and the object detector subsequently being trained based on these images (i.e., the intermediate images). In particular, the object detector may be trained iteratively, wherein prior to the training, a data set of training images of the source domain may be transformed into a data set of intermediate images, with which the object detector is then trained. Alternatively, it is also possible that in each iteration step, an image from the source domain is transformed into an intermediate image and the object detector is then trained on this intermediate image.

Advantageously, the object detector can thus be adapted to the target domain in an unsupervised manner without the need for object annotation for images of the target domain. This speeds up the training process of the object detector since the time for annotating images of the target domain is no longer required. With the same time budget, more images can thus be learned by the object detector. Conversely, this can improve the performance of the object detector since it can be trained on more images.

Generally, an object detector in the sense of the present invention can be understood as being configured to also determine, for an object detection, i.e., in addition to a position and size of an object in the image, a class that characterizes the object of the detection.

The machine learning system in the method for training the object detector may be understood as having been trained according to an embodiment of the method for training the machine learning system according to the present invention. In particular, the method steps for training the machine learning system may therefore be part of the method for training the object detector. In particular, the method steps of training the machine learning system may precede the method steps of training the object detector.

In a further aspect, the present invention relates to a computer-implemented method for determining a control signal for controlling an actuator and/or a display device. According to an example embodiment of the present invention, the method includes the following steps:
providing an input image;
determining, by means of an object detector, objects depicted in the input image, wherein the object detector has been trained based on a characteristic of the method for training the object detector;
determining the control signal based on the determined objects;
controlling the actuator and/or the display device according to the control signal.

The actuator can in particular be understood as a technical system component that affects movement of the technical system or within the technical system. For example, the actuator may be a motor that affects the movement of a robot, for example, an electric motor. Alternatively, it is also possible for the actuator to control a hydraulic system; for example, the actuator may be a pump driving a hydraulic cylinder. The actuator may also be a valve that controls a supply quantity of a liquid or gas.

Example embodiments of the present invention are explained in greater detail below with reference to the figures.

### BRIEF DESCRIPTION OF THE DRAWINGS

FIG. 1 illustrates a machine learning system, according to an example embodiment of the present invention.

FIG. 2 schematically illustrates a method for training the machine learning system, according to an example embodiment of the present invention.

FIG. 3 schematically illustrates a training system, according to an example embodiment of the present invention.

FIG. 4 schematically illustrates a structure of a control system for controlling an actuator, according to an example embodiment of the present invention.

FIG. 5 schematically illustrates an exemplary embodiment for controlling an at least semiautonomous robot, according to the present invention.

FIG. 6 schematically illustrates an exemplary embodiment for controlling a production system, according to the present invention.

FIG. 7 schematically illustrates an exemplary embodiment for controlling an access system, according to the present invention.

FIG. 8 schematically illustrates an exemplary embodiment for controlling a monitoring system, according to the present invention.

### DETAILED DESCRIPTION OF EXAMPLE EMBODIMENTS

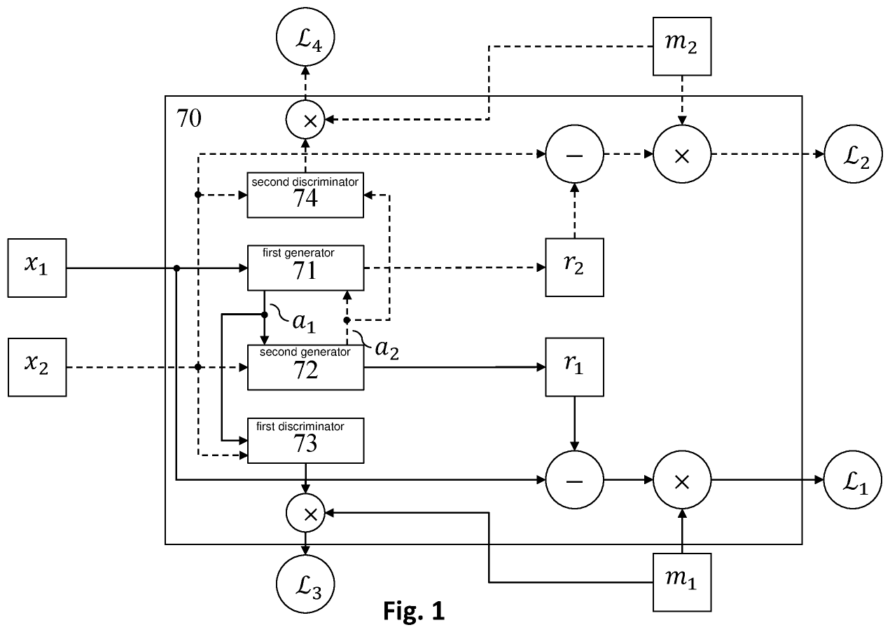

FIG. 1 shows how loss values ( [symbol] , [symbol] , [symbol] , [symbol] ) for training a machine learning system (70) can be determined by means of a source image (x₁) from a source domain and a target image (x₂) from a target domain.

The source image (x₁) is passed to a first generator (71) of the machine learning system (70), wherein the generator (71) determines a first generated image (a₁) based on the source image (x₁). Furthermore, the target image (x₂) is passed to a second generator (72) of the machine learning system (70), wherein the second generator (72) determines a second generated image (a₂) based on the target image (x₂).

The first generated image (a₁) is supplied to the second generator (72) in order to determine a first reconstruction (r₁). Subsequently, differences of the first generated image (a₁) and of the first reconstruction (r₁) are determined pixel by pixel, for example, a respective per-pixel distance according to an Lₚ standard. The differences are subsequently weighted by means of a first attention map (m₁) and the weighted differences are summed in order to determine a first loss value ( [symbol] ).

The second generated image (a₂) is supplied to the first generator (71) in order to determine a second reconstruction (r₂). Subsequently, differences of the second generated image (a₂) and of the second reconstruction (r₂) are determined pixel by pixel, for example, a respective pixel distance according to an Lₚ standard. The differences are subsequently weighted by means of a second attention map (m₂) and the weighted differences are summed in order to determine a second loss value ( [symbol] ).

The target image (x₂) and the first generated image (a₁) are furthermore supplied to a first discriminator (73). The first generator (71) and the first discriminator (73) can be understood as a generative adversarial network (GAN). Based on the target image (x₂) and the first generated image (x₁), the first discriminator (73) then determines a first GAN loss value for each pixel of the first generated image (a₁) and for each pixel of the target image (x₂). In other words, in contrast to the normal GAN loss value, the average of the per-pixel loss values is not used. The first GAN loss values can be understood as a matrix of loss values, in which a loss value at a position corresponds to a pixel position of the target image (x₂) and of the first generated image (a₁). The first GAN loss values are subsequently weighted by means of the first attention map (m₁), and the weighted loss values are summed in order to determine a third loss value ( [symbol] ).

The source image (x₁) and the second generated image (a₂) are furthermore supplied to a second discriminator (74). The second generator (72) and the second discriminator (74) can be understood as a GAN. Based on the source image (x₁) and the second generated image (x₂), the second discriminator (74) then determines a second GAN loss value for each pixel of the second generated image (a₂) and for each pixel of the target image (x₁). In other words, in contrast to the normal GAN loss value, the average of the per-pixel loss values is not used. The second GAN loss values can be understood as a matrix of loss values, in which a loss value at a position corresponds to a pixel position of the source image (x₁) and of the second generated image (a₂). The second GAN loss values are subsequently weighted by means of the second attention map (m₂), and the weighted loss values are summed in order to determine a fourth loss value ( [symbol] ).

The loss values ( [symbol] , [symbol] , [symbol] , [symbol] ) can subsequently be summed, preferably summed weighted, in order to obtain a single loss value by means of which parameters of the first generator (71) and/or parameters of the second generator (72) and/or parameters of the first discriminator (73) and/or of the second discriminator (74) can be changed. The weights of the individual loss values ( [symbol] , [symbol] , [symbol] , [symbol] ) represent hyperparameters of the method.

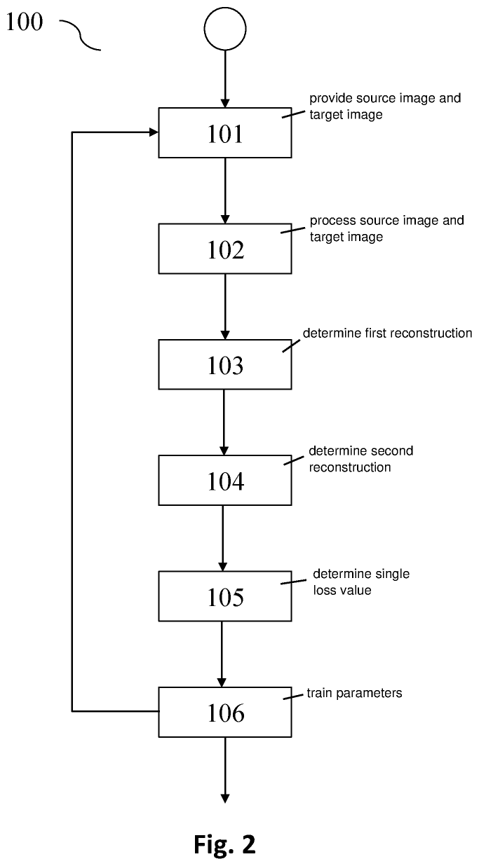

FIG. 2 shows, in the form of a flow chart, the sequence of a training method (100) of the machine learning system (70). In the exemplary embodiment, the machine learning system is designed as a CycleGAN according to FIG. 1. In other embodiments, other designs are also possible.

In a first step (101), a source image is provided from a data set of a source domain and a target image is provided from a data set of a target domain.

In a second step (102), by means of a pre-trained object detector, for example, a neural network designed for object detection, the source image (x₁) and the target image (x₂) are processed in order to determine object detections in each case. Based on the object detections, a first attention map (m₁) is then determined with respect to the source image (x₁) and a second attention map (m₂) is determined with respect to the target image (x₂).

In a third step (103), the first reconstruction (r₁) is determined according to FIG. 1.

In a fourth step (104), the second reconstruction is determined according to FIG. 1.

In a fifth step (105), the single loss value is determined according to FIG. 1.

In a sixth step (106), the parameters of the first generator (71), the parameters of the second generator (72), the parameters of the first discriminator (73), and the parameters of the second discriminator (74) are trained by means of a gradient descent method, and the machine learning system (70) is thus trained.

Preferably, the steps of the method can be repeated iteratively. For example, as a termination criterion of the iteration loop, it may be selected that a specific number of iterations have been completed. Alternatively, it is also possible for the training to be terminated based on the single loss value or a loss value determined on a further data set.

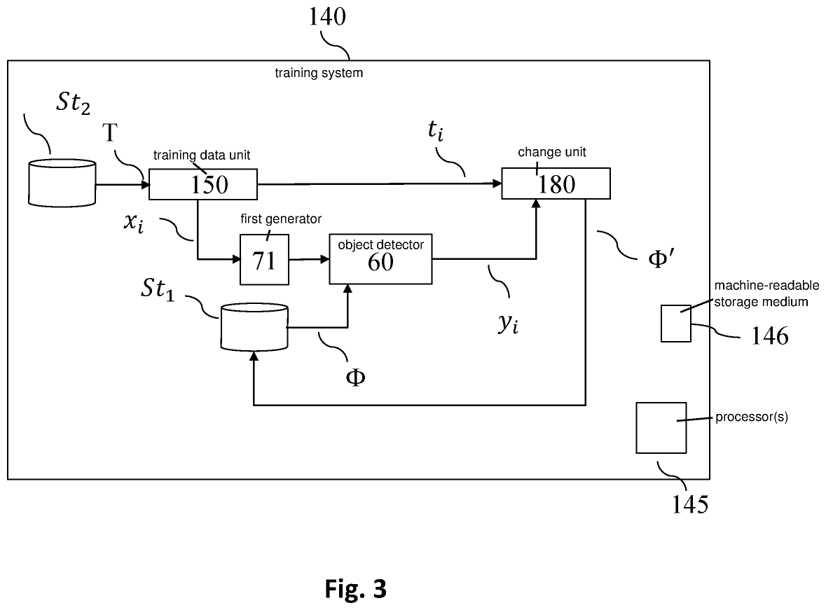

FIG. 3 shows an exemplary embodiment of a training system (140) for training an object detector (60) by means of a training data set (T). The training data set (T) comprises a plurality of source images (xᵢ) of one of the source domains used to train the object detector (60), wherein the training data set (T) furthermore comprises, for each source image (xᵢ), a desired output signal (tᵢ), which corresponds to the source image (xᵢ) and characterizes an object detection of the source image (xᵢ).

For the training, a training data unit (150) accesses a computer-implemented database (St₂), wherein the database (St₂) provides the training data set (T). The training data unit (150) determines, preferably randomly, from the training data set (T), at least one source image (xᵢ) and the desired output signal (tᵢ) corresponding to the source image (xᵢ), and transmits the source image (xᵢ) to the first generator (71) of the trained machine learning system (70). The first generator (71) determines an intermediate image on the basis of the source image (xᵢ). The intermediate image is similar in appearance to images of the target domain. The intermediate image is subsequently supplied to the object detector (60). On the basis of the intermediate image, the object detector (60) determines an output signal (yᵢ).

The desired output signal (tᵢ) and the determined output signal (yᵢ) are transmitted to a change unit (180).

Based on the desired output signal (tᵢ) and the determined output signal (yᵢ), new parameters (Φ) for the object detector (60) are then determined by the change unit (180). For this purpose, the change unit (180) compares the desired output signal (tᵢ) and the determined output signal (yᵢ) by means of a loss function. The loss function determines a first loss value that characterizes how far the determined output signal (yᵢ) deviates from the desired output signal (tᵢ). In the exemplary embodiment, a negative log-likehood [sic] function is selected as the loss function. In alternative exemplary embodiments, other loss functions are also possible.

It is furthermore possible that the determined output signal (yᵢ) and the desired output signal (tᵢ) each comprise a plurality of sub-signals, for example, in the form of tensors, wherein a respective sub-signal of the desired output signal (tᵢ) corresponds to a sub-signal of the determined output signal (yᵢ). For example, it is possible that a first sub-signal of the output signal (tᵢ) respectively characterizes a probability of occurrence of an object with respect to a part of the source image (xᵢ) and a second sub-signal of the output signal (yᵢ) characterizes the exact position of the object. In the event that the determined output signal (yᵢ) and the desired output signal (tᵢ) comprise a plurality of corresponding sub-signals, a second loss value is preferably determined for respectively corresponding sub-signals by means of a suitable loss function and the determined second loss values are suitably merged into the first loss value, for example via a weighted sum.

The change unit (180) determines the new parameters (Φ′) on the basis of the first loss value. In the exemplary embodiment, this is done by means of a gradient descent method, preferably stochastic gradient descent, Adam, or AdamW. In further exemplary embodiments, the training may also be based on an evolutionary algorithm or a second-order optimization.

The determined new parameters (Φ) are stored in a model parameter memory (St₁). Preferably, the determined new parameters (Φ′) are provided as parameters (Φ) to the object detector (60).

In further preferred exemplary embodiments, the described training is iteratively repeated for a predefined number of iteration steps or is iteratively repeated until the first loss value falls below a predefined threshold value. Alternatively, or additionally, it is also possible that the training is terminated if an average first loss value with respect to a test or validation data set falls below a predefined threshold value. In at least one of the iterations, the new parameters (Φ′) determined in a previous iteration are used as parameters (Φ) of the object detector (60).

Furthermore, the training system (140) may comprise at least one processor (145) and at least one machine-readable storage medium (146) containing instructions that, when executed by the processor (145), cause the training system (140) to carry out a training method according to one of the aspects of the invention.

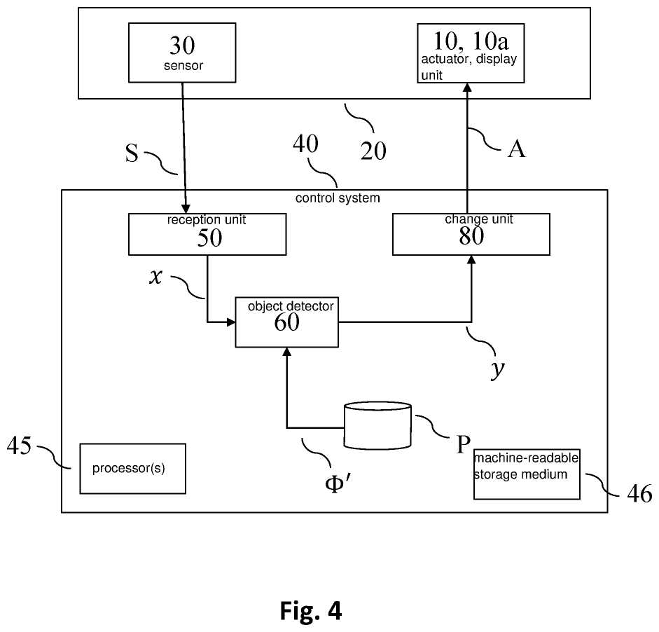

FIG. 4 shows the use of the object detector (60) within a control system (40) for controlling an actuator (10) in an environment (20) of the actuator (10). At preferably regular intervals, the environment (20) is sensed by means of a sensor (30), in particular an imaging sensor, such as a camera sensor, which may also be given by a plurality of sensors, for example, a stereo camera. The sensor signal (S) or, in the case of several sensors, one sensor signal (S) each, of the sensor (30) is transmitted to the control system (40). The control system (40) thus receives a sequence of sensor signals (S). Therefrom, the control system (40) determines control signals (A), which are transmitted to the actuator (10).

The control system (40) receives the sequence of sensor signals (S) of the sensor (30) in an optional reception unit (50), which converts the sequence of sensor signals (S) into a sequence of input images (x) (alternatively, the sensor signal (S) may also respectively be directly adopted as an input image (x)). For example, the input image (x) may be a section or a further processing of the sensor signal (S). In other words, the input image (x) is determined depending on the sensor signal (S). The sequence of input signals (x) is supplied to the object detector (60).

The object detector (60) is preferably parameterized by parameters (Φ) stored in and provided by a parameter memory (P).

The object detector (60) determines output signals (y) from the input signals (x). Output signals (y) are supplied to an optional conversion unit (80), which therefrom determines control signals (A), which are supplied to the actuator (10) in order to control the actuator (10) accordingly.

The actuator (10) receives the control signals (A), is controlled accordingly, and carries out a corresponding action. The actuator (10) can comprise a control logic (not necessarily structurally integrated) which determines, from the control signal (A), a second control signal by means of which the actuator (10) is then controlled.

In further embodiments, the control system (40) comprises the sensor (30). In yet further embodiments, the control system (40) alternatively or additionally also comprises the actuator (10).

In further preferred embodiments, the control system (40) comprises at least one processors (45) and at least one machine-readable storage medium (46) in which instructions are stored that, when executed on the at least one processor (45), cause the control system (40) to carry out the method according to the invention.

In alternative embodiments, as an alternative or in addition to the actuator (10), a display unit (10a) is provided.

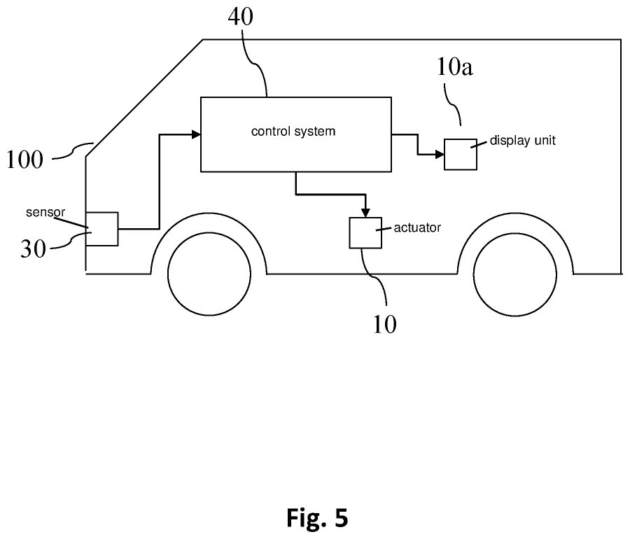

FIG. 5 shows how the control system (40) can be used to control an at least semiautonomous robot, here an at least semiautonomous motor vehicle (100).

The sensor (30) may, for example, be a video sensor preferably arranged in the motor vehicle (100).

The object detector (60) is configured to identify recognizable objects in the input images (x).

The actuator (10) preferably arranged in the motor vehicle (100), may, for example, be a brake, a drive, or a steering of the motor vehicle (100). The control signal (A) may then be determined in such a way that the actuator(s) (10) are controlled in such a way that, for example, the motor vehicle (100) prevents a collision with the objects identified by the object detector (60), in particular if they are objects of specific classes, e.g., pedestrians.

Alternatively, or additionally, the control signal (A) may be used to control the display unit (10a) and, for example, the identified objects are shown. It is also possible that the display unit (10a) is controlled with the control signal (A) to output an optical or acoustic warning signal when it is determined that the motor vehicle (100) is at risk of colliding with one of the identified objects. The warning by means of a warning signal may also take place by means of a haptic warning signal, for example via a vibration of a steering wheel of the motor vehicle (100).

Alternatively, the at least semiautonomous robot may also be a different mobile robot (not shown), for example, one that moves by flying, swimming, diving, or walking. For example, the mobile robot may also be an at least semiautonomous lawnmower or an at least semiautonomous cleaning robot. Even in these cases, the control signal (A) can be determined in such a way that drive and/or steering of the mobile robot are controlled in such a way that the at least semiautonomous robot prevents, for example, a collision with objects identified by the object detector (60).

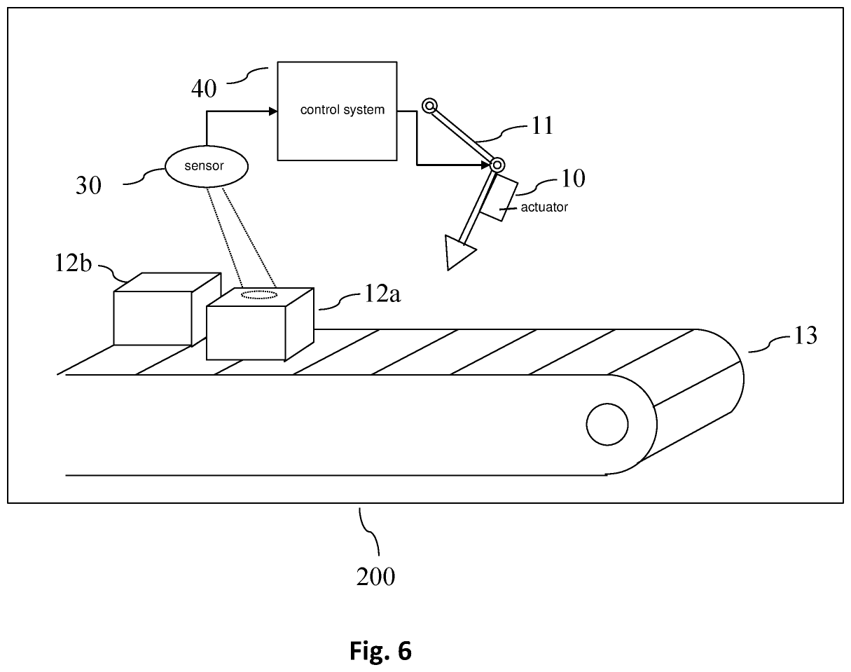

FIG. 6 shows an exemplary embodiment in which the control system (40) is used to control a production machine (11) of a production system (200) by controlling an actuator (10) controlling the production machine (11). For example, the production machine (11) may be a machine for punching, sawing, drilling, welding, and/or cutting. Furthermore, it is possible that the production machine (11) is designed to grip a manufacturing product (12a, 12b) by means of a gripper.

For example, the sensor (30) may be a video sensor that senses, for example, the conveying surface of a conveyor belt (13), wherein manufacturing products (12a, 12b) may be located on the conveyor belt (13). In this case, the input signals (x) are input images (x). For example, the object detector (60) may be configured to determine a position of the manufacturing products (12a, 12b) on the conveyor belt. The actuator (10) controlling the production machine (11) may then be controlled depending on the determined positions of the manufacturing products (12a, 12b). For example, the actuator (10) may be controlled to punch, saw, drill, and/or cut a manufacturing product (12a, 12b) at a predetermined location of the manufacturing product (12a, 12b).

Furthermore, it is possible that the object detector (60) is designed to determine further properties of a manufacturing product (12a, 12b) as an alternative or in addition to the position. In particular, it is possible that the object detector (60) determines whether a manufacturing product (12a, 12b) is defective and/or damaged. In this case, the actuator (10) may be controlled in such a way that the production machine (11) rejects a defective and/or damaged manufacturing product (12a, 12b).

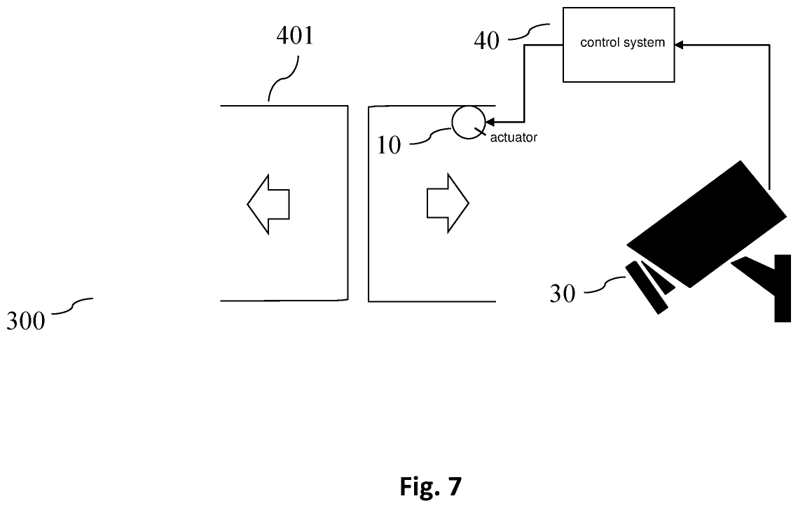

FIG. 7 shows an exemplary embodiment in which the control system (40) is used to control an access system (300). The access system (300) may comprise a physical access control, for example, a door (401). The sensor (30) may in particular be a video sensor or thermal imaging sensor configured to sense an area in front of the door (401). In particular, the object detector (60) may detect persons on a transmitted input image (x). If several persons have been detected simultaneously, the identity of the persons can be determined particularly reliably by associating the persons (i.e., the objects) with one another, for example by analyzing their movements.

The actuator (10) may be a lock that, depending on the control signal (A), releases the access control, or not, for example, opens the door (401), or not. For this purpose, the control signal (A) may be selected depending on the output signal (y) determined by means of the object detector (60) for the input image (x). For example, it is possible that the output signal (y) comprises information that characterizes the identity of a person detected by the object detector (60), and the control signal (A) is selected based on the identity of the person.

A logical access control may also be provided instead of the physical access control.

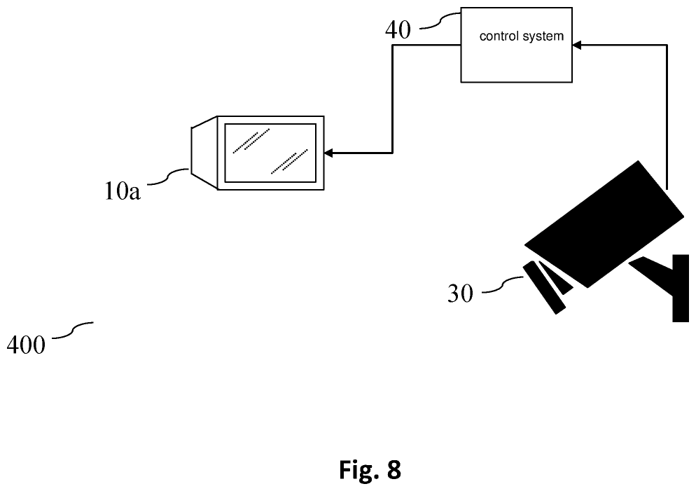

FIG. 8 shows an exemplary embodiment in which the control system (40) is used to control a monitoring system (400). From the exemplary embodiment shown in FIG. 4, this exemplary embodiment differs in that instead of the actuator (10), the display unit (10a) is provided, which is controlled by the control system (40). For example, the sensor (30) may record an input image (x) in which at least one person can be recognized, and the position of the at least one person can be detected by means of the object detector (60). The input image (x) may then be displayed on the display unit (10a), wherein the detected persons may be shown highlighted in color.

The term “computer” comprises any device for processing pre-determinable calculation rules. These calculation rules may be present in the form of software, in the form of hardware or also in a mixed form of software and hardware.

Generally, a plurality can be understood as indexed, i.e., each element of the plurality is assigned a unique index, preferably by assigning successive integers to the elements included in the plurality. Preferably, if a plurality comprises N elements, wherein N is the number of elements in the plurality, the integers from 1 to N are assigned to the elements.

What is claimed is:

1. A computer-implemented method for training a machine learning system, the method comprising the following steps:
providing a source image from a source domain and a target image of a target domain;
determining a first generated image based on the source image using a first generator of the machine learning system, and determining a first reconstruction based on the first generated image using a second generator of the machine learning system;
determining a second generated image based on the target image using the second generator, and determining a second reconstruction based on the second generated image using the first generator;
determining a first loss value, wherein the first loss value characterizes a first difference of the source image and of the first reconstruction, and wherein the first difference is weighted according to a first attention map, and determining a second loss value, wherein the second loss value characterizes a second difference of the target image and of the second reconstruction, and wherein the second difference is weighted according to a second attention map;
training the machine learning system by training the first generator and/or the second generator based on the first loss value and/or the second loss value.

2. The method according to claim 1, wherein: (i) the first attention map respectively characterizes for each pixel of the source image whether or not the pixel belongs to an object depicted in the source image, and/or (ii) the second attention map respectively characterizes for each pixel of the target image whether or not the pixel belongs to an object depicted in the target image.

3. The method according to claim 1, wherein: (i) the first attention map is determined based on the source image using an object detector, and/or (ii) the second attention map is determined based on the target image using the object detector.

4. The method according to claim 3, wherein the steps of the method are performed iteratively and the object detector determines a first attention map for a source image in each iteration and/or determines a second attention map for a target image in each iteration.

5. The method according to claim 4, wherein the object detector is configured to determine objects in images of traffic scenes.

6. The method according to claim 1, wherein the machine learning system characterizes a CycleGAN.

7. A computer-implemented method for training an object detector, the method comprising the following steps:
providing an input image and an annotation, wherein the annotation characterizes a position of at least one object depicted in the input image;
determining an intermediate image using a first generator of a machine learning system trained by:
providing a source image from a source domain and a target image of a target domain,
determining a first generated image based on the source image using a first generator of the machine learning system, and determining a first reconstruction based on the first generated image using a second generator of the machine learning system,
determining a second generated image based on the target image using the second generator, and determining a second reconstruction based on the second generated image using the first generator,
determining a first loss value, wherein the first loss value characterizes a first difference of the source image and of the first reconstruction, and wherein the first difference is weighted according to a first attention map, and determining a second loss value, wherein the second loss value characterizes a second difference of the target image and of the second reconstruction, and wherein the second difference is weighted according to a second attention map, and
training the machine learning system by training the first generator and/or the second generator based on the first loss value and/or the second loss value; and
training the object detector in such a way that for the intermediate image as input, the object detector predicts the object or objects that are characterized by the annotation.

8. A computer-implemented method for determining a control signal for controlling an actuator and/or a display device, the method comprising the following steps:
providing a second input image;
determining, using a trained object detector, objects depicted in the input image, wherein the object detector is trained by:
providing an input image and an annotation, wherein the annotation characterizes a position of at least one object depicted in the input image;
determining an intermediate image using a first generator of a machine learning system trained by:
providing a source image from a source domain and a target image of a target domain,
determining a first generated image based on the source image using a first generator of the machine learning system, and determining a first reconstruction based on the first generated image using a second generator of the machine learning system,
determining a second generated image based on the target image using the second generator, and determining a second reconstruction based on the second generated image using the first generator,
determining a first loss value, wherein the first loss value characterizes a first difference of the source image and of the first reconstruction, and wherein the first difference is weighted according to a first attention map, and determining a second loss value, wherein the second loss value characterizes a second difference of the target image and of the second reconstruction, and wherein the second difference is weighted according to a second attention map,
training the machine learning system by training the first generator and/or the second generator based on the first loss value and/or the second loss value; and
training the object detector in such a way that for the intermediate image as input, the object detector predicts the object or objects that are characterized by the annotation;
determining the control signal based on the determined objects; and
controlling the actuator and/or the display device according to the control signal.

9. A training device configured to train a machine learning system, the training device configured to:
provide a source image from a source domain and a target image of a target domain;
determine a first generated image based on the source image using a first generator of the machine learning system, and determining a first reconstruction based on the first generated image using a second generator of the machine learning system;
determine a second generated image based on the target image using the second generator, and determining a second reconstruction based on the second generated image using the first generator;
determine a first loss value, wherein the first loss value characterizes a first difference of the source image and of the first reconstruction, and wherein the first difference is weighted according to a first attention map, and determining a second loss value, wherein the second loss value characterizes a second difference of the target image and of the second reconstruction, and wherein the second difference is weighted according to a second attention map; and
train the machine learning system by training the first generator and/or the second generator based on the first loss value and/or the second loss value.

10. A non-transitory machine-readable storage medium on which is stored a computer program for training a machine learning system, the computer program, when executed by a processor, causing the processor to perform the following steps:
providing a source image from a source domain and a target image of a target domain;
determining a first generated image based on the source image using a first generator of the machine learning system, and determining a first reconstruction based on the first generated image using a second generator of the machine learning system;
determining a second generated image based on the target image using the second generator, and determining a second reconstruction based on the second generated image using the first generator;
determining a first loss value, wherein the first loss value characterizes a first difference of the source image and of the first reconstruction, and wherein the first difference is weighted according to a first attention map, and determining a second loss value, wherein the second loss value characterizes a second difference of the target image and of the second reconstruction, and wherein the second difference is weighted according to a second attention map; and
training the machine learning system by training the first generator and/or the second generator based on the first loss value and/or the second loss value.
